(19) United States
(12) Patent Application Publication
(10) Pub. No.: US 2022/0297976 A1
(43) Pub. Date: Sep. 22, 2022

(54) METHOD AND DEVICE FOR DETERMINING MULTIPLE ABSOLUTE CAR POSITIONS OF AN ELEVATOR CAR WITHIN A SHAFT OF AN ELEVATOR ARRANGEMENT

(71) Applicant: Inventio AG, Hergiswil (CH)

(72) Inventors: Christian Studer, Kriens (CH); Valerio Villa, Colverde (IT)

(21) Appl. No.: 17/596,835

(22) PCT Filed: Jun. 24, 2020
(86) PCT No.: PCT/EP2020/067608

§ 371 Date: Dec. 20, 2021

(30) Foreign Application Priority Data
Jun. 28, 2019 (EP) 19183108.0

(51) Int. Cl. B66B 1/34; B66B 5/00

(52) U.S. Cl. CPC B66B 1/3492; B66B 1/3461; B66B 5/0018

(57) ABSTRACT

A method for determining multiple absolute positions of an elevator car within a shaft of an elevator arrangement uses a portable smart device (smart phone) having a sensor (camera). The method steps include: displacing the elevator car along the shaft during a learning procedure with the portable smart device being releasably attached at a predetermined position at the elevator car; detecting localizing characteristics at each of multiple locations during the learning procedure, the localizing characteristics indicating an absolute position within the shaft, wherein the localizing characteristics are generated by markers such as QR-codes and are detected using the sensor of the portable smart device; communicating information indicating the absolute positions detected during the learning procedure from the portable smart device to an elevator controller; and correlating each of the absolute positions detected during the learning procedure to one of the multiple absolute car positions and storing derived correlation data.

### FIELD

The present invention relates to a method for determining multiple absolute car positions of an elevator car within an elevator shaft of an elevator arrangement. The invention also relates to a portable smart device, an elevator arrangement and a computer program product which are configured for executing, controlling or being used in such method, and to a computer readable means comprising such computer program product.

### BACKGROUND

An elevator arrangement comprises an elevator car in which passengers may be transported vertically along an elevator shaft between various floors in a building. Therein, passengers may enter or exit the elevator car through shaft doors arranged in the elevator shaft at each of the floors. The elevator car is displaced using a drive engine. An operation of the drive engine is controlled by an elevator controller.

Upon operation of the elevator arrangement, the controller should be configured for controlling the drive engine such that the elevator car may be displaced and stopped at predefined positions adjacent to each one of the shaft doors at one of the floors. Therein, a stopping position should be precisely adapted such that a bottom of the elevator car is aligned and flush with a bottom at the adjacent floor and no step forming a potential tripping hazard is formed.

In order to precisely control the displacement of the elevator car and its current location, the elevator controller requires detailed information about the elevator car's current position within the elevator shaft.

For such purpose, conventional elevator arrangements typically comprise markers for example formed by magnets arranged adjacent to each of the shaft doors in the elevator shaft. A detector for detecting the markers, i.e. for example a magnetic field detector such as a Hall sensor, may then be arranged at the elevator car. Upon being displaced through the elevator shaft together with the elevator car and reaching the position of one of the markers, such sensor may sense the marker, i.e. for example the magnetic field generated by the marker. The sensor may then transmit a signal to the elevator controller indicating that the elevator car arrived at a predefined stopping location next to one of the shaft doors and the elevator controller may then suitably stop the displacement motion of the elevator car.

Exemplarily, EP 2 516 304 B1 discloses a floor position detection device of an elevator system, the device having a sensor unit with a Hall sensor.

U.S. 2016/214832 A1 discloses a method for determining multiple absolute car positions of an elevator car using a combination of a floor sensor and an IC-tag reader.

U.S. 2007/246306 A1 discloses a method for setting the floor associations of a plurality of operating units of an elevator installation using a portable smart device.

However, in such conventional approach, substantial hardware in the form of various markers and at least one sensor has to be provided and installed within the elevator arrangement. Accordingly, substantial efforts and costs are required for implementing such approach for determining the elevator car's current position.

### SUMMARY

There may be a need for an alternative approach or method for determining multiple absolute car positions of an elevator car within a shaft of an elevator arrangement. Particularly, there may be a need for such approach or method which allows reducing installation efforts and/or hardware costs. Furthermore, there may be a need for a portable smart device, an elevator arrangement and a computer program product for executing, controlling and/or being used in such method, and for a computer readable medium comprising the computer program product stored thereon.

Such needs may be met with the subject-matter of one of the advantageous embodiments that are defined in the subsequent specification.

According to a first aspect of the present invention, a method for determining multiple absolute car positions of an elevator car within a shaft of an elevator arrangement using a portable smart device comprising a sensor is proposed. The method comprises at least the following steps, preferably, but not necessarily, in the indicated order:

displacing the elevator car along the shaft during a learning procedure with the portable smart device being releasable attached at a predetermined position at the elevator car,

detecting localizing characteristics at each of multiple locations during the learning procedure, the localizing characteristics indicating an absolute position within the shaft, wherein the localizing characteristics are detected using the sensor of the portable smart device,

communicating an information indicating the absolute positions detected during the learning procedure from the portable smart device to an elevator controller, and

correlating each of the absolute positions detected during the learning procedure to one of the multiple absolute car positions and storing derived correlation data.

According to a second aspect of the invention, a portable smart device is proposed, the portable smart device being configured for one of executing, controlling and being used in the method according to an embodiment of the first aspect of the invention.

According to a third aspect of the invention, an elevator arrangement comprising an elevator controller is proposed. Therein, the elevator arrangement with its controller are configured for cooperating with a portable smart device for executing, controlling and/or being used in the method according to an embodiment of the first aspect of the invention.

According to a fourth aspect of the invention, a computer program product comprising a processor readable code is proposed, wherein the processor readable code, when executed by a portable smart device, instructs the portable smart device for executing, controlling and/or being used in the method according to an embodiment of the first aspect of the invention.

According to a fifth aspect of the invention, a computer readable means comprising a computer program product according to an embodiment of the fourth aspect of the invention stored thereon.

Ideas underlying embodiments of the present invention may be interpreted as being based, inter alia and without restricting the scope of the invention, on the following observations and recognitions.

As indicated in the above introductory portion, conventional floor position detection devices in an elevator system typically comprise sensors for detecting markers attached at predetermined positions within the elevator shaft. Therein, both the sensors and the markers are generally fixedly installed within the elevator system. Accordingly, substantial efforts have to be made for permanently installing all components of such floor position detection device for a long-term service within a building. Furthermore, substantial costs are added to the overall costs of the elevator system due to the various components of the floor position detection device.

Briefly summarized, embodiments of the approach described herein may address both of these deficiencies of conventional approaches by using a portable smart device for determining absolute car positions within the shaft of an elevator arrangement. Therein, the portable smart device is generally not fixedly installed within the elevator arrangement but is attached to the elevator car only during a learning procedure. Such learning procedure typically takes only between some minutes and a few hours. Accordingly, the portable smart device does not have to be fixed to the elevator car in a manner as otherwise required for long-term service. Furthermore, the portable smart device typically has its own power source such as a battery and/or its own data communication interface for example for wireless data communication such that no wiring with other elevator components for energy supply and/or data communication are required. Furthermore, the portable smart device may be used for multiple applications in various elevator arrangements and, possibly, may also serve for other purposes, such that the portable smart device does not add any substantial costs to the overall costs of the elevator arrangements.

The portable smart device may be any device which has some data processing capability and which may be easily carried by a person such as a technician due to its small size and low weight of typically less than 10 kg, in many cases less than 0.5 kg. Furthermore, the portable smart device generally is programmable. Due to its data processing capability and its programmable nature, the portable device is said to have some kind of intelligence and is therefore referred to be “smart”. The portable smart device generally has a processor and some data memory. Typically, the portable smart device has also an own energy source such as a battery. For example, the portable smart device may be a mobile phone, particularly a smart phone. Alternatively, the portable smart device may be any other computing device such as a laptop, a notepad, etc. The portable smart device may be a personalized device. Particularly, the portable smart device may be owned by a person such as a technician which may use the portable smart device also for other purposes.

According to the invention, before initiating the learning procedure, the portable smart device is temporarily attached at a predetermined position at the elevator car. After completion of the learning procedure, the portable smart device is then released again from the fixation at the elevator car.

In other words, the portable smart device may have to be attached to the elevator car only for the duration of the learning procedure. Before and after the learning procedure, the portable smart device may be released from the elevator car and may possibly be used for other purposes. Preferably, the portable smart device may be attached to and released from the elevator car in a manner such that no tools are required.

Therein, the portable smart device should be attached to the elevator car at a predetermined position such that its position relative to the elevator car is precisely known. Accordingly, upon detecting an absolute position of the portable smart device, a correlated absolute position of the elevator car may be concluded.

For example, according to an embodiment, the portable smart device may be attached to a holder fixedly installed at the elevator car.

Such holder may be a simple component such as a casing or a housing at which or in which the portable smart device may be held in a releasable manner during the learning procedure. The holder may be a simple and cheap component. Accordingly, the holder may generally be fixedly installed to the elevator car and remain at the elevator car for the entire service life of the elevator car without significantly contributing to overall costs of the elevator arrangement.

Preferably, the holder is attached to the elevator car at its outside contour. Particularly, the holder may be configured and may be located at the elevator car such that the portable smart device, when attached to the holder, is outside the elevator car such that its sensor may interact with and/or detect characteristics provided within the elevator shaft. For example, the holder may be attached to a bottom of the elevator car.

According to a specific embodiment, the holder may be installed at the elevator car at a predetermined location relative to a sill of the elevator car.

Preferably, the holder is directly installed at the sill of the elevator car. An upper surface of such sill typically corresponds or is flush with an upper surface of a bottom of the elevator car. Accordingly, upon the holder being installed at a predetermined location relative to the sill of the elevator car, the portable smart device being attached to the holder may detect its own absolute position and, subsequently, the absolute position of the sill of the elevator car may be precisely derived from such information. Having determined such absolute position of the sill, the elevator car may be displaced and precisely stopped at a floor such that no step is generated between the sill of the elevator car and a bottom at the neighboring floor.

Upon the portable smart device being attached to the elevator car, the learning procedure may be started. During the learning procedure, the elevator car is displaced along the shaft. Preferably, on such trip, the elevator car is driven along the entire length of the shaft, i.e. from close to one end to close to an opposite end of the shaft. Accordingly, the elevator car preferably reaches all possible locations and, particularly, all locations of floor stops, accessible during normal operation of the elevator arrangement. The elevator car may be continuously driven along the shaft. Alternatively, the elevator car may be displaced along the shaft in partial steps and the displacement may be interrupted by stops, for example stops at floor levels. A velocity of the elevator car during the learning procedure may be same as or slower than during normal operation of the elevator arrangement.

During the learning procedure, the sensor of the portable smart device is used for detecting localizing characteristics at each of multiple locations throughout the elevator shaft. Therein, the localizing characteristics may be features that, on the one hand, may be unambiguously detected by the sensor of the portable smart device and which, on the other hand, may unambiguously indicate an absolute position within the elevator shaft.

Generally, the localizing characteristics may be any kind of physical characteristics which may be detected by a suitable sensor. For example, the localizing characteristics may be local particularities in a physical characteristic such as an optical characteristic, an electrical characteristic, a magnetic characteristic, etc. Preferably, the localizing characteristics may be of a short-range nature and may therefore only be detected upon the sensor being in close proximity of e.g. less than 1 m, preferably less than 0.5 m, less than 0.2 m or even less than 5 cm, to a component generating the localizing characteristics. Accordingly, a sensor being capable of detecting such particularities may be used for detecting the localizing characteristics when arriving at their absolute position within the elevator shaft.

Preferably, the localizing characteristics may be of a nature such that they may be detected in a contactless manner. Accordingly, the sensor does not need to come into mechanical contact with any component generating the localizing characteristics, but it may be sufficient for the sensor to come into close proximity to such component. Thereby, wear or damaging of the sensor may be prevented.

According to an embodiment, the sensor may be an optical sensor and the localizing characteristics may be detected optically using the sensor.

In other words, the localizing characteristics may be implemented by a feature which may be detected optically and the sensor may be an optical sensor specifically configured for detecting such optical feature. Optically detecting such visual localizing characteristics may generally be established in a contactless manner. Furthermore, optically detectable localizing characteristics may be easily implemented using for example markers which are cheap and/or easy to install. The named markers can be installed before the final shaft is build, i.e. in a factory where shaft elements are fabricated.

For example, according to an embodiment, the sensor may be a camera and the localizing characteristics may be detected based on an image acquired by the camera.

Expressed differently, the sensor may be a camera being configured for taking two-dimensional images or even videos. Therein, a resolution of the camera may be at least 100×100 pixels and may be such that the optical localizing characteristics may be unambiguously detected. Typically, modern portable smart devices such as smart phones comprise a camera which may be easily used for detecting visual localizing characteristics.

Generally, the visual localizing characteristics may be any characteristics being present within the elevator shaft which are, on the one hand, optically detectable and which, on the other hand, are arranged at a pre-known position.

For example, according to an embodiment, the localizing characteristics may be markers fixed within the shaft at each of the multiple locations.

In other words, the localizing characteristics may be implemented using specific markers. For example, during installation of the elevator arrangement, such markers may be arranged at various locations throughout the elevator shaft at predetermined positions. The markers may be adapted for generating the above-mentioned local particularities in physical characteristics.

For example, according to a specific embodiment, the markers may comprise an individual optically readable pattern.

The individual optically readable pattern may be unique for each of the markers in an elevator arrangement. For example, the pattern may be a bar code or a QR code. By reading such individual optically readable pattern using an optical sensor, for example an identity of the respective marker may be detected. Based on for example predetermined knowledge about the absolute position of each identified marker, absolute positions within the elevator shaft may then be easily determined based on the detected localizing characteristics of the marker. Alternatively or additionally, the optically readable pattern may encrypt information about the absolute position of the marker carrying this pattern.

Generating the localizing characteristics using markers, specifically using markers comprising an individual bar code or a QR code, may be a particularly simple way to implement the method proposed herein, as such localizing characteristics may be generated and installed simply and cost effective and may be easily detected by a sensor such as a camera of a portable smart device.

However, it is to be noted that various other ways of generating the localizing characteristics and detecting such localizing characteristics may be applied alternatively. For example, typical formations such as sills of shaft doors may be detected using suitable image analysis of images taken by a camera of a portable smart device and may then serve as localizing characteristics for determining an absolute position within the elevator shaft. Alternatively, other physical means such as for example magnets may be attached at suitable locations throughout the elevator shaft in a temporary or stationary manner such as to generate the localizing characteristics to be detected by suitable sensors of portable smart devices.

According to an embodiment, each of the localizing characteristics defines a position of a shaft door at one of multiple floors within the shaft.

In other words, the localizing characteristics or markers generating the localizing characteristics may be positioned and configured such that each of them defines a position of one of the shaft doors at one of the floors in a building served by the elevator arrangement. Accordingly, by detecting the absolute position of the localizing characteristics, an information about an absolute position of the associated shaft door may be obtained.

Particularly, according to an embodiment, each of the localizing characteristics may define a position of a sill at a shaft door at one of multiple floors within the shaft.

Accordingly, by detecting the localizing characteristics, an information about the position of the sill of an associated shaft door may be obtained. Knowing the absolute position of such sill may then enable stopping the elevator car precisely such that its bottom level is flush with such sill.

Upon having detected the localizing characteristics, the information about the absolute position detected during the learning procedure may be communicated from the portable smart device to the elevator controller. For example, the portable smart device may directly transmit information to the elevator controller upon having detected one of the localizing characteristics, the information indicating the localizing characteristics and/or its absolute position. Optionally, the portable smart device may collect all such information and may then transmit all information to the elevator controller in one procedure.

Preferably, the portable smart device may transmit the information to the elevator controller via a wireless data interface. Optionally, the portable smart device may send the information to an external server or to a data cloud from which the elevator controller may download this information.

Finally, the absolute positions detected during the learning procedure are correlated to one of the multiple absolute car positions to be determined. The derived correlation data indicating the correlation between each of the absolute positions detected during the learning procedure to an associated one of the absolute car positions are then stored.

In other words, during the learning procedure, the elevator car is displaced to various locations throughout the elevator shaft and absolute positions are learned by detecting localizing characteristics. These absolute positions are then identified to indicate the current absolute position of the elevator car. Therein, a set-off may be calculated e.g. based on the information about the relative position of the smart portable device with regard to the car position to be determined, such absolute car position indicating for example a position of the sill of the elevator car. Data correlating each of the absolute positions detected during the learning procedure to a current position of the elevator car are referred to as correlation data and are stored for subsequent use during normal operation of the elevator arrangement. For example, such data may be stored in an internal memory of the elevator controller or in an external server or in a data cloud.

Later, during normal operation of the elevator arrangement, a current position of the elevator car is generally determined using other technical means. For example, a strip of a magnetic material may be installed along the elevator shaft and location information may be stored on such magnetic strip and may be read by a sensor being attached to the elevator car. However, as the strip is installed along the elevator shaft, the location information stored on the strip initially is no information about an absolute position but depends on the relative location of the strip within the elevator shaft.

Accordingly, in the learning procedure, additional information about absolute positions are learned by detecting the localizing characteristics at each of multiple locations. Subsequently, during normal operation, this information about the absolute positions may be correlated to information about the current position of the elevator car obtained by the other technical means and, based on the previously obtained correlation data, information about a current absolute position of the elevator car may be derived.

It may be noted that the approach described herein may be applicable to elevator arrangements as long as it may be assumed that a geometry of the elevator shaft is stable in time and does not change after the absolute car positions have been learned during the learning procedure. This is typically true for elevator arrangements applied in not very tall buildings, i.e. for example an elevator arrangement serving less than 30 floors, preferably less than ten floors.

In contrast hereto, high-rise buildings tend to shrink over time such that the length of the elevator shaft and/or absolute positions within the elevator shaft may change over time. In such cases, it may be necessary to repeat the approach described herein periodically, i.e. repeatedly perform the learning procedure after certain times or to repeat it only once after the building has settled, in order to recalibrate position measurements.

If there are shaft doors not only at one side of the elevator shaft, but i.e. on two sides, the described procedure is performed for each side.

A programmable portable mobile device may be adapted to executing, controlling and/or being used in the approach described herein by programming its functions using a specific computer program product. Such computer program product may also be referred to as application or app. The computer program product may be programmed in any computer language.

The computer program product may be stored on any computer readable medium. Such computer readable medium may be for example a storage means such as a CD, a DVD, a flash memory or similar devices. Alternatively, the computer program product may be stored on a computer, on a server or in a data cloud from which it may be downloaded.

It shall be noted that possible features and advantages of embodiments of the invention are described herein partly with respect to a method for determining multiple absolute car positions, partly with respect to a portable mobile device configured for executing, controlling and/or being used in such method and partly with respect to an elevator arrangement comprising an controller being configured for cooperating with such portable smart device for executing, controlling and/or being used in such method. One skilled in the art will recognize that the features may be suitably transferred from one embodiment to another and features may be modified, adapted, combined and/or replaced, etc. in order to come to further embodiments of the invention.

In the following, advantageous embodiments of the invention will be described with reference to the enclosed drawing. However, neither the drawing nor the description shall be interpreted as limiting the invention.

### DESCRIPTION OF THE DRAWINGS

FIG. 1 shows an elevator arrangement in which a portable mobile device is applied for determining multiple absolute car positions in accordance with an embodiment of the present invention.

The FIGURE is only schematic and not to scale. Same reference signs refer to same or similar features.

### DETAILED DESCRIPTION

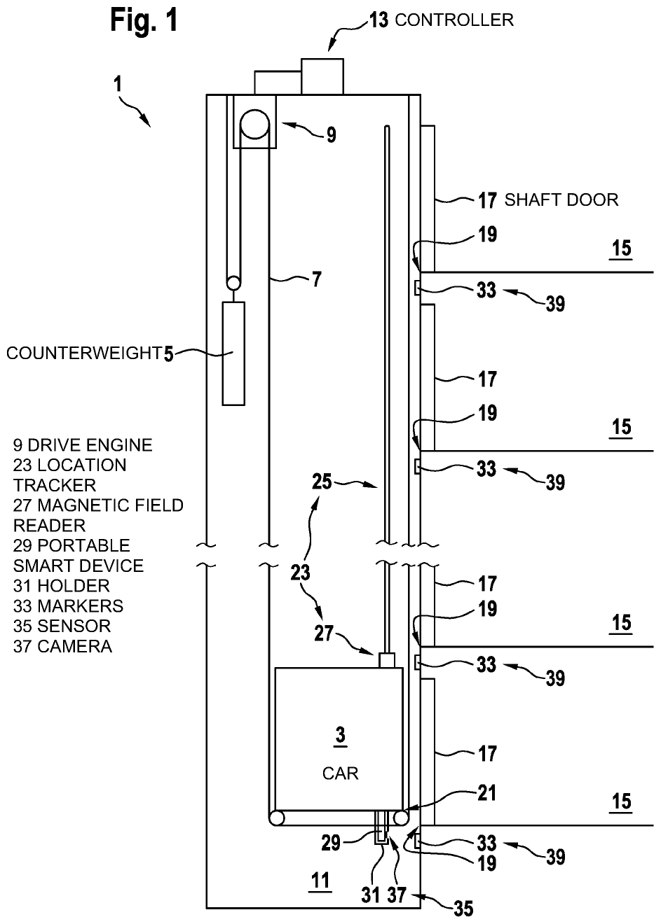

FIG. 1 shows an elevator arrangement 1. Therein, an elevator car 3 and a counterweight 5 are suspended by a suspension and traction means 7. A drive engine 9 may displace the suspension and traction means 7 in order to thereby move the elevator car 3 and the counterweight 5 within an elevator shaft 11. An operation of the drive engine 9 is controlled by a controller 13. Accordingly, the elevator car 3 may be displaced to each of various floors 15. At each of the floors 15, a shaft door 17 is provided to selectively open or block an access to the elevator shaft 11 and to the elevator car 3 waiting at one of the floors 15.

It is intended that the controller 13 may control the drive engine 9 such as to precisely displace and stop the elevator car 3 at intended locations throughout the elevator shaft 11. For example, the elevator car 3 shall be stopped at one of the floors 15 such that a position of a sill 21 of the elevator car 3 substantially corresponds to a position of a sill 19 at a bottom of the respective floor 15, i.e. both sills 19, 21 are substantially flush with each other.

In order to determine the local position of the elevator car 3 during normal operation of the elevator arrangement 1, the elevator arrangement 1 typically comprises a location tracker 23. In the example represented in FIG. 1, this location tracker 23 comprises a magnetic strip 25 and a magnetic field reader 27. The magnetic strip 25 extends along the elevator shaft 11. The magnetic field reader 27 is attached to the elevator car 3. On the magnetic strip 25, information is encoded depending on the location within the elevator shaft 11. Accordingly, by reading out this information using the magnetic field reader 27, the local position of the elevator car 3 in relation to the magnetic strip 25 may be determined.

However, the absolute location of the magnetic strip 25 within the elevator shaft 11 is initially not known. In other words, upon having installed the elevator arrangement 1 within a building, it is not yet known where the magnetic strip 25 is exactly located relative for example to the shaft doors 17.

Therefore, a learning procedure has to be performed prior to starting normal operation of the elevator arrangement 1. In such learning procedure, information about absolute positions within the elevator shaft 11 are to be acquired such that the absolute car position may be determined based on such information.

Accordingly, in an embodiment of the method for determining multiple absolute car positions of the elevator car 3 within the elevator shaft 11, a portable smart device 29 is used. The portable smart device 29 comprises a sensor 35 such as a camera 37. The portable smart device 29 may be a smart phone or a similar processor-controlled mobile device which is driven by a specific app.

Before starting the learning procedure, the portable smart device 29 is attached to the elevator car 3 in a releasable manner. For this purpose, a holder 31 is fixed to the elevator car 3. The holder 31 is arranged at a predetermined location relative to the elevator car 3. For example, the holder 31 may be fixed to a bottom of the elevator car 3 close to the sill 21 of the elevator car 3. The portable smart device 29 may be installed within this holder 31. As the position of the holder 31 relative to the elevator car 3 is known, also the position of the portable smart device 29 relative to the elevator car 3 is known.

At multiple locations throughout the elevator shaft 11, markers 33 are attached to sidewalls of the shaft 11 at precisely known absolute positions. For example, one marker 33 may be provided at or adjacent to one of the sills 19 at each of the floors 15. Each marker 33 may form a localizing characteristic 39 which may be detected by the sensor 35 of the portable smart device 29. For example, these markers may comprise individual optically readable patterns such as bar codes or QR codes.

With the portable smart device 29 being held at the holder 31, the elevator car 3 is displaced along the shaft 11 during the learning procedure. When the elevator car 3 and the portable smart device 29 attached thereto come close to one of the localizing characteristics 39 generated by the markers 33, the sensor 35 of the portable smart device 29 may detect such localizing characteristic 39. In other words, in the example given above, the camera 37 of the smart portable device 29 may read out the bar code or QR code displayed at the marker 33. As the absolute position of the localizing characteristic 39 is known, also the absolute position of the portable smart device 29 at the moment when it detects this localizing characteristic 39 is known.

The absolute positions detected during the learning procedure are transmitted from the portable smart device 29 to the elevator controller 13. Such data transmission may be established for example in a wireless manner.

Finally, the absolute positions detected during the learning procedure may be correlated to a corresponding one of the multiple absolute car positions and derived correlation data may then be stored. For example, such data storing may be done within the controller 13 or within a computer, an external server or a data cloud communicating with this controller 13.

Having derived and stored this correlation data during the learning procedure, the correlation data may be used for calibrating position data to be used later during normal operation of the elevator arrangement 1.

For example, the location tracker 23 may be calibrated accordingly such that the readouts of its magnetic field reader 27 may be interpreted to indicate not only positions relative to the magnetic strip 25 but absolute car positions within the elevator shaft 11.

Accordingly, having completed the learning procedure as described herein, the elevator car 3 may be precisely displaced and stopped at absolute positions within the elevator shaft 11.

The approach described herein allows for various benefits. For example, substantial costs may be saved as there is no fixed sensor to pay for and to install, and there is no need for special brackets to hold marker magnets at the shaft doors over long-term periods, etc. Instead, a technician may only need to have a smart phone to be used during the learning procedure. An elevator manufacturer may control who puts in service an elevator as the elevator manufacturer may distribute a suitable app to different phones of authorized technicians. Furthermore, work efforts for conducting the learning procedure may be reduced as for example the portable smart device 29 may be easily attached to the elevator car 3 and simple markers 33 may be easily attached within the elevator shaft 11 at predetermined positions.

Finally, it should be noted that the term “comprising” does not exclude other elements or steps and the “a” or “an” does not exclude a plurality. Also, elements described in association with different embodiments may be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

1-14. (canceled)

15. A method for determining multiple absolute car positions of an elevator car within a shaft of an elevator arrangement using a portable smart device having a sensor, the method comprising the steps of:
displacing the elevator car along the shaft during a learning procedure with the portable smart device being releasably attached at a predetermined position at the elevator car;
detecting localizing characteristics at each of multiple locations in the shaft during the learning procedure using the sensor of the portable smart device, the localizing characteristics each indicating an associated absolute position within the shaft;
communicating information indicating the absolute positions detected during the learning procedure from the portable smart device to an elevator controller of the elevator arrangement;
correlating each of the absolute positions detected during the learning procedure to one of the multiple absolute car positions and storing correlation data derived from the correlating;
temporarily attaching the portable smart device at a predetermined position at the elevator car prior to performing the learning procedure; and
releasing the portable smart device from the elevator car after completion of the learning procedure.

16. The method according to claim 15 wherein the sensor is an optical sensor and the localizing characteristics are detected optically using the sensor.

17. The method according to claim 15 wherein the sensor is a camera and the localizing characteristics are detected based on images acquired by the camera during the learning procedure.

18. The method according to claim 15 wherein the localizing characteristics are markers fixed within the shaft at each of the multiple locations.

19. The method according to claim 18 wherein the markers include an individual optically readable pattern.

20. The method according to claim 15 wherein each of the localizing characteristics indicates a position of a shaft door at one of multiple floors within the shaft.

21. The method according to claim 15 wherein each of the localizing characteristics indicates a position of a sill at a shaft door at one of multiple floors within the shaft.

22. The method according to claim 15 wherein the portable smart device is releasably attached to a holder fixedly installed at the elevator car.

23. The method according to claim 22 wherein the holder is installed at the elevator car at a predetermined location relative to a sill of the elevator car.

24. A portable smart device adapted to perform at least one of executing and controlling the method according to claim 15.

25. An elevator arrangement comprising an elevator controller, wherein the elevator arrangement with the elevator controller are adapted to cooperate with a portable smart device for at least one of executing and controlling the method according to claim 15.

26. A computer program product comprising a processor readable code which code, when executed by a portable smart device, instructs the portable smart device to perform at least one of executing and controlling the method according to claim 15.

27. A non-transitory computer readable medium comprising a computer program product according to claim 26 stored thereon.

28. A method for determining multiple absolute car positions of an elevator car within a shaft of an elevator arrangement, the method comprising the steps of:
providing a portable smart device having a sensor;
temporarily attaching the portable smart device at a predetermined position on the elevator car;
displacing the elevator car with the portable smart device along the shaft during a learning procedure;
detecting localizing characteristics at each of multiple locations in the shaft during the learning procedure using the sensor of the portable smart device, the localizing characteristics each indicating an associated absolute position within the shaft;
communicating information indicating the absolute positions detected during the learning procedure from the portable smart device to an elevator controller of the elevator arrangement;
correlating each of the absolute positions detected during the learning procedure to one of multiple absolute car positions to be determined and storing derived correlation data indicating a correlation between each of the absolute positions detected and an associated one of the absolute car positions; and
releasing the portable smart device from the elevator car after completion of the learning procedure.
